(19) United States
(12) Patent Application Publication
(10) Pub. No.: US 2025/0230098 A1
(43) Pub. Date: Jul. 17, 2025

(54) HIGHLY REACTIVE GEOPOLYMER FOAM FORMULATIONS FOR FAST CURE PROCESS

(71) Applicant: DDP SPECIALTY ELECTRONIC MATERIALS US, LLC, Wilmington, DE (US)

(72) Inventors: KYOUNG MOO KOH, MIDLAND, MI (US); MARK RICKARD, MIDLAND, MI (US); GERALD F BILLOVITS, MIDLAND, MI (US)

(21) Appl. No.: 19/024,944

(22) Filed: Jan. 16, 2025

Related U.S. Application Data
(62) Division of application No. 19/024,858, filed on Jan. 16, 2025.
(60) Provisional application No. 63/621,969, filed on Jan. 17, 2024.

(51) Int. Cl. C04B 28/00; C04B 38/02; C04B 40/06; C04B 103/42

(52) U.S. Cl. CPC C04B 28/006; C04B 38/02; C04B 40/065; C04B 2103/42

(57) ABSTRACT

A rapidly-expanding and -curing geopolymer formulation includes a liquid aqueous phase with silicate, aluminate and/or silico-aluminate precursors, an inorganic base, a monosaccharide and/or disaccharide, and a water-soluble peroxy compound. The saccharide and peroxy compound react spontaneously and rapidly in strongly alkaline conditions, producing an expanding gas and exothermic heat of reaction that drives at least an initial cure of the geopolymer formulation. The resulting foamed geopolymer formulation can be used in a variety of building and construction applications, as well as and others.

### BACKGROUND OF THE INVENTION

The present invention relates to geopolymers and methods of making geopolymers.

There is a need to develop non-combustible materials for the construction industry, to replace or supplement flammable organic materials such as wood and organic polymers. Inorganic materials are potential replacement materials. One particular class of inorganic materials, known as “geopolymers”, has potential in these applications because they can be produced from inexpensive, readily available raw materials that form a slurry or paste and can be cast or molded into any arbitrary geometry.

Geopolymers are produced by condensation of aluminosilicate starting materials in the presence of water and a strong base. This produces an amorphous polymeric Si—O—Al framework having tetrahedral aluminosilicate units with alkali metal ions that balance the charge associated with tetrahedral Al. Geopolymers and methods for making them are described, for example, in U.S. Pat. Nos. 4,349,386 and 4,509,985, among many others.

Their adoption into construction and other application areas has been limited in part because they require long times to cure to a tack-free, self-supporting state at ambient temperatures such as are usually encountered at job sites (such as −10° C. to 37° C.). This requirement disqualifies geopolymers from many on-site applications in which faster curing is necessary. For example, adhesive and sealant applications generally require a material that quickly develops adhesive strength, viscosity and/or and “green strength”, in a matter of minutes or hours rather than days.

Shorter initial cure times are desirable even when manufacturing prefabricated products (such as, for example, wall, roof or floor panels, or insulating panels) from geopolymers, to reduce manufacturing cycle time and increase production rates. A fast initial cure would allow the material to be handled shortly after being formed into the desired product. Although curing can be accelerated by applying heat to the geopolymer formulation as it cures, doing so increases costs due to added energy requirements and specialized heating equipment, and it is often not practical to supply heat at an on-site application or to maintain elevated temperature curing conditions for extended periods of time.

Geopolymers, like most other inorganic cementitious materials, have densities much higher than those of organic materials they might replace. The higher density adds significant weight. Therefore, attempts have been made to produce lower-density geopolymers. US Published Patent Application No. 2022/0017410A, for example, describes incorporating chemical blowing agents including carbonates, bicarbonates, hydrazides and peroxides such as hydrogen peroxide and organic peroxides into the geopolymer-forming formulation. Densities as low as 127 kg/m³ are reported, but cure times are three days in a high humidity, ambient temperature atmosphere followed by a drying step at 70° C.

EP 3728159B describes bubbling air or an inert gas into a water-surfactant mixture to produce an aqueous foam that is then combined with the inorganic raw materials to produce a foamed geopolymer. Geopolymer densities as low as 47 kg/m³ are reported. Unfortunately, this process still requires long curing times to a tack-free state and has the further drawback of requiring special equipment for handling the gas and incorporating it into the water-surfactant mixture. As such, the process described in EP 3728159B has limited suitability, especially for on-site application.

What is desired are materials and methods for producing a reduced-density geopolymer that cures rapidly even at ambient temperatures. The geopolymer foam formulation should require mainly inexpensive raw materials and preferably does not require specialized equipment to produce and handle the foam formulation and to cure it to produce the geopolymer product.

### BRIEF SUMMARY OF THE INVENTION

This invention relates to a method of making a foamed geopolymer, comprising the steps of:
(I) forming an alkaline aqueous slurry having a liquid phase that comprises water by combining ingredients comprising (i) one or more inorganic aluminate and/or silicate precursor materials wherein the one or more inorganic aluminate and/or silicate precursor materials provide silicon and aluminum in a mole ratio of 1:1 to 4:1, (ii) one or more inorganic bases selected from alkali metal hydroxides, alkali metal oxides, alkali metal carbonates, alkaline earth hydroxides and alkaline earth oxides, (iii) one or more saccharides selected from monosaccharides and disaccharides (iv) at least three moles of water-soluble peroxy compound per mole of the saccharide and (v) water to disperse and/or dissolve ingredients (i), (ii), (iii) and (iv) into the liquid phase to produce the alkaline aqueous slurry, wherein the one or more saccharides constitute 1 to 10% of the weight of the combined weight of ingredients (i), (ii), (iii), (iv) and (v) and water constitutes 20 to 75% of the combined weight of ingredients (i), (ii), (iii), (iv) and (v), and
(II) curing the alkaline aqueous slurry to produce the foamed geopolymer.

This invention also relates to an expanded geopolymer obtained by curing an alkaline aqueous slurry having a liquid phase that comprises water, the alkaline aqueous slurry comprising (i) one or more inorganic aluminate and/or silicate precursor materials wherein the one or more inorganic aluminate and/or silicate precursor materials provide silicon and aluminum in a mole ratio of 1:1 to 4:1, (ii) one or more inorganic bases selected from alkali metal hydroxides, alkali metal oxides, alkali metal carbonates, alkaline earth hydroxides and alkaline earth oxides, (iii) one or more saccharides selected from monosaccharides and disaccharides and (iv) at least three moles of one or more water-soluble peroxy compounds per mole of saccharides, wherein ingredients (i)-(iv) are dispersed and/or dissolved in the liquid phase, the one or more saccharides constitute 1 to 10% of the weight of the combined weight of ingredients (i), (ii), (iii), (iv) and the water, and water constitutes 20 to 75% of the combined weight of ingredients (i), (ii), (iii), (iv) and the water.

This invention further relates to a two-component reactive system for producing a geopolymer, the system comprising:
(A) a first alkaline aqueous premix having a pH greater than 10 comprising water and one or more inorganic bases selected from alkali metal hydroxides, alkali metal oxides, alkali metal carbonates, alkaline earth hydroxides and alkaline earth oxides, and
(B) a second aqueous premix comprising water and a water-soluble peroxy compound, the second aqueous premix having a pH of 3 to 10 at 25° C., wherein:
(1) at least one of (A) and (B) contains one or more inorganic aluminate and/or silicate precursor materials,
(2) at least one of (A) and (B) contains one or more saccharides selected from monosaccharides and disaccharides,
(3) the one or more inorganic aluminate and/or silicate precursor materials provide silicon and aluminum in a mole ratio of 1:1 to 4:1,
(4) the one or more saccharides constitute 1 to 10% of the combined weight of (A) and (B);
(5) at least three moles of the one or more water-soluble peroxy compounds are present in the first alkaline aqueous per mole of the one or more saccharides, and
(6) water constitutes 20 to 75% of the combined weight of (A) and (B).

### DETAILED DESCRIPTION OF THE INVENTION

This invention is a method of making a foamed geopolymer, comprising the steps of:
(I) forming an alkaline aqueous slurry having a liquid phase that comprises water by combining ingredients comprising (i) one or more inorganic aluminate and/or silicate precursor materials wherein the one or more inorganic aluminate and/or silicate precursor materials provide silicon and aluminum in a mole ratio of 1:1 to 4:1, (ii) one or more inorganic bases selected from alkali metal hydroxides, alkali metal oxides, alkali metal carbonates, alkaline earth hydroxides and alkaline earth oxides, (iii) one or more saccharides selected from monosaccharides and disaccharides, (iv) at least three moles of a water-soluble peroxy compound per mole of saccharide and (v) water to disperse and/or dissolve ingredients (i), (ii), (iii) and (iv) into the liquid phase to produce the alkaline aqueous slurry, wherein the one or more saccharides constitute 1 to 10% of the weight of the combined weight of ingredients (i), (ii), (iii), (iv) and (v) and water constitutes 20 to 75% of the combined weight of ingredients (i), (ii), (iii), (iv) and (v), and
(II) curing the alkaline aqueous slurry to produce the foamed geopolymer.

The method has important advantages. It requires only inexpensive, readily available raw materials that are formulated to produce a flowable slurry, which can be poured, pumped, extruded, sprayed, troweled or otherwise applied and worked. The initial reaction between the saccharide and peroxy compounds commences quickly after the reactants are combined, even when combined at room temperature or below room temperature, rapidly producing gases that expand the slurry. The reaction between the saccharide and peroxy compound is highly exothermic. The exothermic heat of reaction in turn drives the polymerization reaction. Thus, the reactants expand and cure to very rapidly to produce a self-supporting, expanded geopolymer. Further curing can be done at about room temperature if desired, or can be accelerated by heating, such as to a temperature of 50 to 100° C. The cured product is a rigid, non-combustible geopolymer containing gas-filled voids.

Due to these and other attributes, the method is useful in various construction applications, in which the alkaline aqueous slurry can be produced on-site and applied and cured easily. Examples of such construction applications include filling and sealing gaps, cracks and penetrations in a building structure and as applied coatings for building components such as panels, joists, and trusses. Such coatings may, for example, improve the flammability and/or acoustic performance of surfaces to which they are applied.

The method is also useful in a production setting for making manufactured goods such as geopolymer foam insulation boards and composites; ceramic tiles, refractory items, decorative stone-like artifacts, thermal shock refractories and components for vehicles such as aircraft and automobiles. The method can also be used to produce geopolymers for radioactive and toxic waste containment, and also for certain medical applications.

Another advantage of the invention is that the raw materials can be formulated into a two-component reactive system, where each of the components are unreactive and shelf stable for extended periods when maintained separately at temperatures normally encountered during transportation and storage (such as up to 40° C.). This affords significant advantages in packaging, transporting, storing and using the materials. Thus, in another aspect, the invention is a two-component reactive system for producing a geopolymer, the system comprising:
(A) a first alkaline aqueous premix having a pH greater than 10 comprising water and one or more inorganic bases selected from alkali metal hydroxides, alkali metal oxides, alkali metal carbonates, alkaline earth hydroxides and alkaline earth oxides, and
(B) a second aqueous premix comprising water and one or more water-soluble peroxy compounds, the second aqueous premix having a pH of less than 10 at 25° C., wherein:
(1) at least one of (A) and (B) contains one more inorganic aluminate and/or silicate precursor materials,
(2) at least one of (A) and (B) contains one or more saccharides selected from monosaccharides and disaccharides,
(3) the one or more inorganic aluminate and/or silicate precursor materials provide silicon and aluminum in a mole ratio of 1:1 to 4:1,
(4) the one or more saccharides constitute 1 to 10% of the combined weight of (A) and (B);
(5) at least three moles of the one or more water-soluble peroxy compound are present in the first alkaline aqueous premix per mole of the one or more saccharides, and
(6) water constitutes 20 to 75% of the combined weight of (A) and (B).

The invention is also an expanded geopolymer obtained by curing an alkaline aqueous slurry having a liquid phase that comprises water, the alkaline aqueous slurry comprising (i) one or more inorganic aluminate and/or silicate precursor materials wherein the one or more inorganic aluminate and/or silicate precursor materials provide silicon and aluminum in a mole ratio of 1:1 to 4:1, (ii) one or more inorganic bases selected from alkali metal hydroxides, alkali metal oxides, alkali metal carbonates, alkaline earth hydroxides and alkaline earth oxides, (iii) one or more saccharides selected from monosaccharides and disaccharides and (iv) at least three moles of at least one water-soluble peroxy compound per mole of the at least one saccharide, wherein ingredients (i)-(iv) are dispersed and/or dissolved in the liquid phase, the one or more saccharides constitute 1 to 10% of the weight of the combined weight of ingredients (i), (ii), (iii), (iv) and the water, and water constitutes 20 to 75% of the combined weight of ingredients (i), (ii), (iii), (iv) and the water.

Ingredient (i) is one or more inorganic aluminates, silicates, or alumino-silicates. These materials, singly or in combination, provide silicon and aluminum in a mole ratio of 1:1 to 4:1. This ratio may be at least 1.25:1, at least 1.5:1 or at least 1.75:1, and may be up to 3:1. up to 2.5:1 or up to 2.25:1.

Inorganic aluminate precursor materials comprise aluminum and oxygen bonded to the aluminum, including, for example, alumina (Al₂O₃) and alkali metal aluminates, particularly sodium and/or potassium aluminate.

Inorganic silicate precursor materials comprise silicon and oxygen bonded to the silicon and include, for example, amorphous forms of silica such as microsilica and fumed silica, ground glass, sand, and alkali metal silicates, particularly sodium and/or potassium silicate. An especially useful inorganic silicate precursor material is a water-soluble alkali metal silicate, particularly potassium silicate and most preferably sodium silicate. The term “alkali metal silicates” includes various compounds represented by the formula M₂ₓSi_{y}O_{(2y+x)} or (SiO₂)_{y}·(M₂O)ₓ, where M is sodium and/or potassium and y and x are positive numbers having a ratio of 1 to 2.85, especially 1 to 2.5 or 1:2.0. “Sodium silicate”, therefore, typically is a mixture of sodium metasilicate (Na₂SiO₃), sodium orthosilicate (Na₄SiO₄), and sodium pyrosilicate (Na₆Si₂O₇) and optionally other species represented by the general formula M₂ₓSi_{y}O_{(2y+x)}. Alkali metal silicates are conveniently provided in the form of an aqueous solution.

Inorganic alumino-silicate precursors comprise silicon and aluminum, each of which are bonded to oxygen. These include, for example, various clays, especially kaolin; various industrial slags such as blast furnace slag and steel slag; fly ashes such as brown-coal fly ash and hard-coal fly ash; alumino-silicate glasses; natural pozzolans such as tuff, trass and volcanic ash; and metakaolin. Metakaolin, an anhydrous calcined form of kaolin having the approximate empirical formula Al₂O₇Si₂ (sometimes expressed using the notation Al₂O₃2SiO₂), is an especially preferred alumino-silicate precursor.

In especially preferred embodiments, ingredient (i) comprises a mixture of sodium silicate and metakaolin that provides a silicon:aluminum mole ratio of 1.5:1 to 2.5:1, especially 1.75:1 to 2.25:1.

Ingredient (i) may constitute, for example, at least 20%, at least 30% or at least 35% of the combined weight of ingredients (i), (ii), (iii), (iv) and (v), and may constitute up to, for example, 70%, up to 60% or up to 50% thereof.

Ingredient (ii) is preferably an alkali metal hydroxide, more preferably potassium hydroxide, sodium hydroxide or a mixture thereof, and most preferably sodium hydroxide. Ingredient (ii) may be provided in the form of substantially anhydrous (water content <5% by weight, for example) solid particles, or in the form of an aqueous solution. In general, enough of ingredient (ii) is provided such that the aqueous alkaline slurry has a pH of at least 10, preferably at least 11. pH can be measured in any convenient manner capable of determining such high pH values, including wetting pH paper with the aqueous alkaline slurry.

Ingredient (iii) preferably is a monosaccharide. Ingredient (iii) may be a reducing sugar and may be an aldose sugar, in each case preferably being a monosaccharide. The preferred monosaccharide in some embodiments has six carbon atoms; examples of these include but are not limited to glucose, mannose, galactose, allose, altrose and talose. In other embodiments the preferred monosaccharide has five carbon atoms such as xylose, arabinose, lyxose and ribose. Xylose is a preferred monosaccharide based on its reactivity with hydrogen peroxide in the presence of alkali, and its ready availability. Monosaccharides may be the L- or D-isomer, or a mixture of both isomers. Examples of disaccharides include sucrose, lactose, trehalose and maltose. Ingredient (iii) may be provided in aqueous solution if desired. The one or more saccharide(s) may constitute 1 to 10%, preferably 2 to 10% or 2 to 7.5% of the weight of the combined weight of ingredients (i), (ii), (iii), (iv) and (v).

Ingredient (iv) is a peroxy compound, i.e., a compound having at least one —O—O-linkage. Water-soluble peroxides, peroxyesters, peroxycarbonates and the like are suitable. The peroxy compound may be organic, provided it is soluble in water, but more preferably is inorganic. Inorganic peroxy compounds include hydrogen peroxide, alkali metal peroxides such as sodium peroxide and potassium peroxide, and alkali metal peroxycarbonates such as sodium peroxycarbonate and potassium peroxycarbonate. Hydrogen peroxide is most preferred The water-soluble peroxy compound preferably is provided as a solution in water. At least 3 moles of water-soluble peroxy compound are provided per mole of saccharide; at least 5 moles are preferred when the saccharide is a C5 monosaccharide and at least 6 moles are preferred when the saccharide is a C₆ monosaccharide. Greater amounts water-soluble peroxy compounds, such as up to 10 or up to 20 moles of water-soluble peroxy compound per mole of saccharide, or even more, may be used.

Water (ingredient v) in general constitutes 20 to 75% of the combined weight of ingredients (i), (ii), (iii), (iv) and (v). This amount includes water from all sources, including the water introduced with aqueous solutions and/or dispersions of other ingredients. This amount of water is generally sufficient to dissolve the water-soluble ingredients and produce a slurry having manageable rheological properties. A preferred amount of water is at least 30% or at least 40% on the foregoing basis, and up to 65% or up to 60%, again on the foregoing basis.

An alkaline aqueous slurry is prepared by mixing the foregoing ingredients. The ingredients can be combined using simple mixing methods adequate to wet out any solid starting materials and obtain uniform distribution. This can be performed at a temperature of, for example, −10° C. to 40° C., especially 0° C. to 37° C. or 10° C. to 37° C. The ingredients can be combined at higher temperatures if desired, although this is not necessary and the reaction of the saccharide(s) with the water-soluble peroxy compound(s) may be more difficult to control at such higher temperatures.

Since the saccharide/peroxy compound reaction occurs spontaneously when the saccharide and peroxy compound are combined in an alkaline environment, it is preferred to keep at least one of these ingredients (the saccharide, peroxy compound and any alkaline materials) separate from the others until the other ingredients are or have been combined.

It is often convenient to formulate the alkaline aqueous slurry into a two-component reactive system, particularly for use in on-site applications. The two-components are kept separate until such time as they are combined to form an alkaline aqueous slurry that cures to produce the geopolymer. This reduces the need to store, measure and combine materials on-site, can reduce formulating errors and generally improves ease-of-use. To prevent premature reaction and promote shelf-stability, the two-component reactive system is formulated to keep at least one of the saccharide, hydrogen peroxide and alkaline materials separate from the others until the two components of the two-component reactive system are combined and cured to produce the expanded geopolymer.

In such embodiments, one component is a first alkaline aqueous premix that comprises water and one or more inorganic bases selected from alkali metal hydroxides, alkali metal oxides, alkali metal carbonates, alkaline earth hydroxides and alkaline earth oxides. Alkaline aluminate and/or silicate precursors materials such as alkali metal silicates (if used) are also present in the first component. The first alkaline aqueous premix typically has a pH greater than 10, preferably at least 11 or at least 12. The pH may be up to 18 or up to 17. The other component is a second aqueous premix that comprises water and the water-soluble peroxy compounds. The second aqueous premix has a pH less than 10, preferably 3 to 9, 3 to 8 or 4 to 8. The other ingredients (non-alkaline inorganic aluminate and/or silicate precursor materials, the saccharide and optional ingredients as described below), may be distributed freely between the first and second components (including by dividing any of them between the first and second components), provided that alkaline ingredients are included in the first alkaline aqueous premix so the second aqueous premix containing the water-soluble peroxy compound has a pH of at most 10 as described above.

In particular embodiments, the first component comprises the one or more inorganic bases, an alkali metal silicate and at least one alumino-silicate such as described above, preferably metakaolin; and the second component comprises the hydrogen peroxide, monosaccharide and optionally at least one alumino-silicate as described above (preferably meta-kaolin). In such embodiments, the alumino-silicate may if desired be divided between the first and second components, a portion thereof being present in each of the components. This may have benefits in producing first and second components that have similar viscosities (which facilitates easier mixing), and to allow the first and second components to be combined at convenient mix ratios, such as 3:1 to 1:3 by volume, 2:1 to 1:2 by volume or 1:1 by volume, when used to form the geopolymer. The alkaline aqueous slurry produced by mixing the first and second components should have a pH greater than 10, preferably at least 11 or at least 12.

Various optional ingredients may also be provided in the alkaline aqueous slurry. These include various types of surfactants, various water-soluble and/or water-dispersible organic polymers, catalysts for the reaction of hydrogen peroxide and the monosaccharide, colorants, and various fillers.

Surfactants may be provided to stabilize the cell structure of the expanding reaction mixture as it grows in volume and cures and/or as a wetting agent for those ingredients that are not soluble or readily dispersible in water, for example. Surfactants may be nonionic, anionic, cationic or amphiphilic. Examples of nonionic surfactants include but are not limited to polyether block copolymers such as poly(propylene oxide)-poly(ethylene oxide) block copolymers, alkylphenol ethoxylates, ethoxylated fatty acids, ethoxylated fatty alcohols and various silicone surfactants. Examples of anionic surfactants include but are not limited to alkyl sulfates, alkyl-ether sulfates, alkyl-aryl ether sulfates, alkyl benzene sulfonates, fatty carboxylic acid salts, alkyl ether phosphates, alkyl-aryl ether phosphates. Examples of cationic surfactants include but are not limited to various quaternary ammonium compounds having a C8-24 alkyl group such as cetrimonium bromide, cetylpyridinium chloride, benzalkonium chloride, benzethonium chloride, dimethyldioctadecyl ammonium chloride and dioctadecyldimethyammonium bromide. Suitable amphiphilic surfactants are described in US 2020/0017410A. Such surfactants, if present, may constitute 0.1 to 5%, especially 0.25 to 2%, of the combined weight of the surfactant(s) and ingredients (i), (ii), (iii), (iv) and (v).

Water-soluble and/or water-dispersible polymers may be present. They may serve various useful functions, including thickening, imparting thixotropic properties, or other rheological modification. Examples of such water-soluble and/or water-dispersible polymers include but are not limited to hydrophobically-modified ethylene oxide urethane rheology modifiers, non-ionic urethane rheology modifiers, starches, modified starches, cellulose, cellulose ethers such as methyl cellulose and hydroxymethyl cellulose, xanthan gum, carboxymethyl cellulose, alginic acid and salts thereof; acrylic acid homopolymers and copolymers (which may be partially or entirely neutralized) and polystyrene sulfonate. Useful hydrophobically-modified ethylene oxide urethane rheology modifiers and non-ionic urethane rheology modifiers include those sold by The Dow Chemical Company under the trade name Acrysol®. Such water-soluble and/or water-dispersible polymers, if present, may constitute 0.1 to 5%, especially 0.25 to 2%, of the combined weight of the polymer(s) and ingredients (i), (ii), (iii), (iv) and (v).

Another optional ingredient is a catalyst for the reaction of hydrogen peroxide and the one or more monosaccharides. Examples of such catalysts include but are not limited to transition metal compounds, such as iron and/or manganese salts, an example of which is ferrous sulfate, MnO₂ and KMnO₄.

The ingredients of the alkaline aqueous slurry may further comprise (viii) one or more fillers. Fillers, for purposes of this invention, are particulate materials having a length to diameter ratio of 3 or less) that do not react, melt, dissolve, decompose or degrade under the conditions of the geopolymer-forming reaction. Fillers do not take part in the geopolymer-forming reaction(s). Fillers may include, for example, thermoset polymer particles, metal particles and mineral fillers. Mineral fillers may be naturally-occurring and/or synthetic materials. Examples of fillers include basalt, limestone, calcium carbonate, magnesium carbonate, spinels, zirconium oxide, magnesium oxide, tin oxide, titanium dioxide and cerium oxide, boron nitride, silicon nitride, boron carbide, silicon nitride, alkali-resistant glass, carbon and the like.

The ingredients of the alkaline aqueous slurry may further comprise (ix) one or more fibers. Fibers, for purposes of this invention, are particulate materials having an aspect ratio of greater than 3, preferably greater than 10) that do not react, melt, dissolve, decompose or degrade under the conditions of the geopolymer-forming reaction. Fibers do not take part in the geopolymer-forming reaction(s). Examples of suitable fibers may include, for example, thermoset polymer fibers, thermoplastic polymer fibers such as nylon, aramid, polypropylene, polyvinyl alcohol and polyester fibers, various plant fibers including cellulosic fibers, alkali-resistant glass fibers, metal fibers and fibrous mineral whiskers and fibers, carbon fibers.

Inorganic sources of calcium may present in the alkaline aqueous slurry. Some calcium (in the form of oxides, most typically) may be present in one or more of the aluminate and/or silicate precursors, such as certain slags. It is generally preferred that the alkaline aqueous slurry contain no more than 0.5 mole of calcium per mole of silicon, and more preferably no more than 0.25 mole or no more than 0.1 mole of calcium per mole of silicon.

Upon forming the alkaline aqueous slurry, the saccharide and water-soluble peroxy compound react exothermically to produce water and formic acid. This reaction typically occurs spontaneously even at temperatures of −10° C. to 37° C., although some saccharides such as xylose react faster than others such as glucose. Gas evolution is typically seen within 10 seconds to 20 minutes after forming the alkaline aqueous slurry. Gas evolution is seen more rapidly with monosaccharides than with disaccharides, and with more highly reactive monosaccharides such as xylose than with less reactive monosaccharides such as glucose. The selection of saccharide therefore can be a means for adjusting the reactivity, time until gas generation begins, and tack-free time, as may be desired. Similarly, the presence or absence of catalyst, and if present its concentration and type, can be manipulated to adjust the reactivity of the system, if desired.

Expanding gas is generated by one or more mechanisms. The exothermic reaction of the saccharide with water-soluble peroxy compound produces formic acid, which may become neutralized to an alkali metal formate, and may further decompose to produce carbon monoxide, carbon dioxide, and water. The exothermic heat of these reactions can further volatilize water, producing steam that expands the geopolymer. Decomposition of the water-soluble peroxy compound, either catalytically or thermally, yields oxygen gas and water; however, unlike the case in which the saccharide is no present, gas generation in this invention occurs spontaneously and rapidly even when the alkaline aqueous slurry is formed at low temperatures such as approximately room temperature. Applied heat is not necessary to produce expanding gas with this invention.

The exothermic heat generated by the saccharide/water-soluble peroxy compound reaction also provides energy to drive the reaction of the aluminate and/or silicate precursors to produce the geopolymer. The geopolymer-forming reactions are well-known and described, for example, in U.S. Pat. Nos. 4,349,386 and 4,509,985, among others. An advantage of this invention is that the initial curing takes place rapidly; the geopolymer often expands and cures to a self-supporting state in very short periods of time, frequently one hour or less, or even 30 minutes or less, even when the alkaline aqueous slurry is formed at a temperature of −10° C. to 37° C. and allowed to react without applying additional heat. By “self-supporting”, it is meant the partially cured geopolymer maintains its shape and dimensions without lateral support; i.e., when supported only from below. The exothermic reaction of the saccharide is mainly completed rapidly, usually within minutes. Accordingly, unless heat is subsequently applied, the temperature of the reactants tends to reach a maximum shortly after the alkaline aqueous slurry is formed, followed by a subsequent temperature decrease towards ambient. Curing can continue even at ambient temperatures. If desired, heat can be applied to speed geopolymer formation and develop physical properties. Heating, if applied, may be to a temperature of, for example, 60° C. to 200° C., especially 60 to 100° C., for a period of 15 minutes to 6 hours or more. Heating can be applied before or after the geopolymer has cured sufficiently to become expanded and self-supporting. In particularly preferred embodiments, the alkaline aqueous slurry is produced at a temperature of −10° C. to 37° C., especially 10 to 35° C., and partially cured without applying additional heat until an expanded, self-supporting, partially cured geopolymer is obtained. Further curing then may be done by heating the partially cured geopolymer to a temperature of 60° C. to 200° C., especially 60 to 100° C., for a period of 15 minutes to 6 hours or more.

The methods and compositions of the invention are useful in a variety of construction and other applications.

One important construction application is a sealant for filling and sealing gaps, cracks and penetrations in building structures. The two-component reactive system of the invention is particularly well-adapted for such applications, as it allows the starting materials to be formulated and packaged as separate components that can be combined easily at a job site to produce the expanded geopolymer. For example, each of the components may be packaged into a separate tube, which can be mounted onto a dual cartridge dispensing gun, mixed using an inline static mixer and discharged as a homogeneous reactive system.

Another construction application is an adhesive for temporarily or permanently affixing building elements to each other. Similar to sealants, the two-component reactive system of the invention is particularly well-adapted for adhesive applications such as these and can if desired be dispensed and applied in similar manner as described for the sealants. In addition, the alkaline aqueous slurry may be applied in adhesive applications by other methods that allow the slurry to be dispensed immediately after it is formed, such as spraying. A suitable spray apparatus includes a mixhead for combining the ingredients (or subcombinations thereof such as the two-component reactive system of the invention) to form the alkaline aqueous slurry and spray apparatus for immediately dispensing the slurry in the form of an aerosolized suspension of reactive droplets in a carrier gas. When these droplets are deposited on a substrate, they attach to the surface and the overlapping droplets merge and coalesce into a film of the alkaline aqueous slurry, which continues to react as above to form an expanded geopolymer coating,

Another construction application is coatings for building components such as panels, joists, and trusses. Spraying methods are particularly suitable for applying such coatings, but other methods such as dip coating, rolling and/or brushing can be used. Such coatings can be applied on a job site and/or at a manufacturing facility that produces the building component, as may be convenient.

Still another construction application is thermal insulation for building components such as walls and floors. Again, spraying methods are particularly useful for this application although other methods can be used to apply the geopolymer if convenient.

Yet another construction application is wallboard, insulation panels, laminated panels and other boardstock. These may be produced by forming the alkaline aqueous slurry, dispensing it onto a substrate, gauging the geopolymer as it expands to produce a geopolymer layer of predetermined thickness, and then curing the geopolymer. Such products can be produced continuously by dispensing the alkaline aqueous slurry onto the substrate as the substrate is moving, and at least partially curing the alkaline aqueous slurry on the moving substrate to form a self-supporting, expanded geopolymer layer on the substrate. The partial curing step may be performed without applied heat until a self-supporting, expanded geopolymer forms, after which heat can be applied if desired to complete the cure and develop physical properties. Heat may be applied to the substrate with the applied partially cured geopolymer layer in a continuous process by passing the material through an oven, between the belts of a double belt laminator or between a series of heated rollers (which can also gauge the thickness of the board or panel); alternatively, heat can be applied discontinuously. Boards and panels made this way are conveniently cut to length and trimmed if necessary. The substrate may become adhered to the cured geopolymer layer and in such cases may form a layer of the final product. Another layer of substrate may be laid onto the geopolymer layer, either during or after curing, to produce a top layer that may remain with and become part of the final product. For example, paper layers may be used as the top and/or bottom substrates in producing a wallboard or similar panel product. Other substrates include metal sheets or foils, wood, thermoplastic and/or thermoset resins, various felts, various mineral wools, and reinforcing scrims such as polymeric, alkali-resistant glass, metal or cellulosic scrims among others, as are useful for the intended application.

Yet another application is in flame-resistant chip-board panels, as described, for example in U.S. Pat. No. 4,028,454.

Ceramic tiles, in which the expanded geopolymer may constitute the tile or form a layer thereof, such as a substrate layer, represents still another application.

Molded articles are conveniently made by introducing the alkaline aqueous slurry into a mold cavity to partially fill the mold cavity and at least partially curing the alkaline aqueous slurry within the mold cavity such that the alkaline aqueous slurry expands to fill the mold cavity and at least partially cures to produce a self-supporting, expanded geopolymer within the mold cavity. If desired, further curing can be performed within the mold or after demolding the partially cured, self-supporting expanded geopolymer. As before, the curing inside the mold can be performed by applying heat. In an especially preferred process, the alkaline aqueous slurry is prepared at a temperature of −10° C. to 37° C. and introduced into the mold at such temperature, then at least partially cured in the mold without applying additional heat. In such embodiments, curing can be completed in the mold, optionally by heating the mold and its contents to a temperature of 60° C. to 200° C., preferably 60° C. to 100° C.; alternatively, the partially cured geopolymer can be demolded and further cured outside the mold, with or without applying heat.

### Examples

In the following examples, all parts and percentages are by weight unless otherwise indicated. All solutions are in water unless otherwise indicated.

### Examples 1-4 and Comparative Samples A and B

Geopolymers are made from the formulations set forth in Table 1. The formulations are divided into two parts, designated Part A and Part B in Table 1.

TABLE 1

| | Parts By Weight | | | | | |
|---|---|---|---|---|---|---|
| | Comp. | | | Comp. | | |
| Ingredient | A* | Ex. 1 | Ex. 2 | B* | Ex. 3 | Ex. 4 |

Part A

| | | | | | | |
|---|---|---|---|---|---|---|
| 97% NaOH | 0.46 | 0.46 | 0.53 | 0.53 | 0.53 | 0.53 |
| 37% Sodium | 4.62 | 4.62 | 5.33 | 5.33 | 5.33 | 5.33 |
| Silicate Solution | | | | | | |
| Metakaolin | 0.92 | 0.92 | 2.13 | 2.13 | 2.13 | 2.13 |

Part B

| | | | | | | |
|---|---|---|---|---|---|---|
| Xylose | 0 | 1.00 | 1.00 | 0 | 1.00 | 2.00 |
| 30% H₂O₂ Solution | 5.00 | 5.00 | 5.00 | 5.00 | 5.00 | 5.00 |
| Metakaolin | 0 | 0 | 0 | 2.00 | 2.00 | 2.00 |

*Not an example of the invention.

The Part A ingredients are combined and stirred to dissolve the NaOH and disperse the metakaolin powder. Separately the Part B ingredients are combined and shaken until the xylose dissolves. The pH of Part A is in excess of 12; that of Part B is approximately 5 to 8. Parts A and B are then combined at room temperature (about 23° C.). A thermocouple is placed into the resulting reaction mixture and a timer is started.

The Example 1 reaction mixture begins to heat almost immediately due to the exothermic decomposition of the xylose, reaching about 102° C. after about 100 seconds. At that time, the reaction mixture begins to form bubbles and expands rapidly with the evolution of gas, primarily steam. An open-celled, porous solid geopolymer foam forms over the next 20 minutes. After cooling, a portion of the Example 1 geopolymer foam is placed into water, where it floats, indicating it has a density well below 1.0 g/cm³.

The Example 2-4 reaction mixtures react similarly, in each case exhibiting an exothermic temperature rise to over 100° C. and curing rapidly to form a self-supporting, open-celled solid geopolymer foam with a density well below 1.0 g/cm³.

Comparative Samples A and B exhibit almost no exothermic temperature rise when Parts A and B are combined, the peak temperature reaching only about 28° C. No foaming or gas generation is observed, and the reaction mixture remains in the form of a soft paste after one day.

### Examples 5-6 and Comparative Sample C and D

Geopolymers are made in the same general manner as described in the previous set of examples, from formulations as set forth in Table 2.

TABLE 2

| | Parts By Weight | | | |
|---|---|---|---|---|
| Ingredient | Comp. C* | Ex. 5 | Comp. D* | Ex. 6 |

Part A

| | | | | |
|---|---|---|---|---|
| 97% NaOH | 0.46 | 0.46 | 0.46 | 0.46 |
| 37% Sodium Silicate | 4.62 | 4.62 | 4.62 | 4.62 |
| Solution | | | | |
| Metakaolin | 2.13 | 2.13 | 2.13 | 2.13 |

Part B

| | | | | |
|---|---|---|---|---|
| Starch | 0.25 | 0.25 | 0 | 0 |
| Cellulose | 0 | 0 | 0.5 | 0.5 |
| Xylose | 0 | 1.00 | 0 | 1.00 |
| 30% H₂O₂ Solution | 5.00 | 5.00 | 5.00 | 5.00 |
| Metakaolin | 2.00 | 2.00 | 2.00 | 2.00 |

*Not an example of the invention.

The pH of Part A is in excess of 12; that of Part B is approximately 6-8. Examples 5 and 6 exhibit an exothermic temperature rise and begin to expand and cure within 2 minutes of combining parts A and B, in each case forming a foamed geopolymer having a density less than 1 g/cm³. Example 6, which contains cellulose, has greater mechanical strength than Examples 1-4. The presence of starch in Example 5 leads to some foam shrinkage.

As before, Comparative Samples C and D exhibit almost no reaction exotherm and remain uncured after one day.

### Examples 7 and 8

Geopolymers are made in the same general manner as described with regard to Examples 1-4, from formulations as set forth in Table 3.

TABLE 3

Parts By Weight

| | | |
|---|---|---|
| Ingredient | Ex. 7 | Ex. 8 |

Part A

| | | |
|---|---|---|
| 97% NaOH | 0.46 | 0.46 |
| 37% Sodium Silicate Solution | 4.62 | 4.62 |
| Metakaolin | 2.13 | 2.13 |
| Xylose | 1 | 0 |

Part B

| | | |
|---|---|---|
| Xylose | 0 | 1 |
| Cellulose | 0.5 | 0.5 |
| Glycerol | 0 | 1 |
| 30% H₂O₂ Solution | 5 | 5 |
| Metakaolin | 2 | 2 |
| Non-Silicone Surfactant¹ | 0 | 1 |

¹Vorasurf 504, from Dow Chemical.

The pH of Part A is in excess of 12; that of Part B is approximately 6-8. In each case, the reaction mixture reacts exothermically and begins to expand and cure after about 90 seconds, producing a solid geopolymer foam after 20-30 minutes. Example 8 has a finer cell structure due to the presence of the surfactant.

### Examples 9 and 10 and Comparative Sample E

Geopolymers are made by mixing the ingredients indicated in Table 4. All ingredients are combined at room temperature into a one-part formulation having a pH greater than 11. Examples 9 and 10 begin to foam immediately upon mixing the materials and a self-supporting expanded material is obtained within one hour. Examples 9 and 10 are then cured overnight at 80° C. and 60° C., respectively. Comparative Sample E does not foam or expand until it is heated to 80° C. and held at that temperature overnight. Density is measured on each of the products. Thermal conductivity is measured according to ASTM C518-21 (Standard Test Method for Steady-State Thermal Transmission Properties by Means of the Heat Flow Meter Apparatus) and compressive strength is measured according to ASTM C165-23 (Standard Test Method for Measuring Compressive Properties of Thermal Insulations) for Example 9 and Comparative Sample E. Results are as indicated in Table 4.

TABLE 4

| | Parts By Weight | | |
|---|---|---|---|
| Ingredient | Comp. E* | Ex. 9 | Ex. 10 |
| 37% Sodium Silicate Solution | 31.73 | 36.75 | 31.43 |
| 97% NaOH | 3.46 | 3.66 | 3.42 |
| Water | 25.09 | 15.74 | 21.82 |
| Metakaolin | 35.69 | 32.85 | 35.36 |
| 35% H₂O₂ Solution | 3.01 | 7.96 | 6.03 |
| Xylose | 0 | 1.98 | 0.95 |
| Sodium Dodecyl Benzene | 0 | 0.05 | 0 |
| Sulfonate | | | |
| Polyacrylic acid | 0 | 1.01 | 0 |
| Poly(sodium-4-styrene sulfonate) | 1.02 | 0 | 0.99 |

Properties

| | | | |
|---|---|---|---|
| Density (kg/m³) | 401 | 247 | 310 |
| Thermal Conductivity (mW/m · K) | 62 | 54 | ND |
| R-value | 2.3/inch | 2.7/inch | ND |
| Compressive Strength, psi (kPa) | 30.9 | 12.1 | |

*Comparative.
ND is not done.

### Example 11

Geopolymer Example 11 is made by mixing the ingredients indicated in Table 5. The pH of Part A is estimated as in excess of 12; that of Part B as approximately 6-8. Part A and Part B are combined at room temperature and foaming begins immediately thereafter. The reaction mixture is expanded and self-supporting within an hour. Further curing is performed overnight at 60° C. to produce a hard, cellular geopolymer.

TABLE 5

| | |
|---|---|
| Ingredient | Weight % |

Part A

| | |
|---|---|
| Sodium silicate (37% in water) | 29.28 |
| NaOH | 3.19 |
| Water | 3.15 |
| Metakaolin | 13.94 |
| Poly(sodium 4-styrenesulfonate) | 0.44 |

Part B

| | |
|---|---|
| Water | 15.76 |
| Metakaolin | 19.01 |
| Hydrogen peroxide (35% in water) | 12.16 |
| Xylose | 2.51 |
| Poly(sodium 4-styrenesulfonate) | 0.56 |

### Examples 12 and 13

Geopolymers are made in the same general manner as described with regard to Examples 1-4, from formulations as set forth in Table 6.

TABLE 6

Parts by Weight

| | | |
|---|---|---|
| Ingredient | Ex. 12 | Ex. 13 |

Part A

| | | |
|---|---|---|
| 97% NaOH | 0.46 | 0.46 |
| 37% Sodium Silicate Solution | 4.62 | 4.62 |
| Metakaolin | 2.13 | 2.13 |

Part B

| | | |
|---|---|---|
| Cellulose | 0.5 | 0.5 |
| Glucose | 1.0 | 0 |
| Galactose | 0 | 1.5 |
| Hydrogen Peroxide (35% in water) | 5 | 5 |
| Metakaolin | 2 | 2 |
| Surfactant | 0.4 | 0.4 |

Parts A and B are combined at room temperature in each case. The reaction mixtures expand and partially cure without applying heat, albeit the rate of reaction is much slower with these hexose sugars than is seen in previous examples with the pentose sugar (xylose).

What is claimed is:

1. A two-component reactive system for producing a geopolymer, the system comprising:
(A) a first alkaline aqueous premix having a pH greater than 10 comprising water and one or more inorganic bases selected from alkali metal hydroxides, alkali metal oxides, alkali metal carbonates, alkaline earth hydroxides and alkaline earth oxides, and
(B) a second aqueous premix comprising water and one or more water-soluble peroxy compounds, the second aqueous premix having a pH of 3 to 10 at 25° C., wherein:
(1) at least one of (A) and (B) contains one or more inorganic aluminate and/or silicate precursor materials,
(2) at least one of (A) and (B) contains one or more saccharides selected from monosaccharides and disaccharides,
(3) the one or more inorganic aluminate and/or silicate precursor materials provide silicon and aluminum in a mole ratio of 1:1 to 4:1,
(4) the one or more saccharides constitute 1 to 10% of the combined weight of (A) and (B);
(5) at least three moles of the one or more water-soluble peroxy compounds are present per mole of the one or more saccharides, and
(6) water constitutes 20 to 75% of the combined weight of (A) and (B).

2. The two-component reactive system of claim 1 wherein the one or more inorganic aluminate and/or silicate precursor materials provide silicon and aluminum in a mole ratio of 1.25:1 to 2.5:1.

3. The two-component reactive system of claim 1 wherein the one or more inorganic aluminate and/or silicate precursor materials constitute 30 to 60% of the combined weight of the one or more inorganic bases, one or more water-soluble peroxy compounds, one or more inorganic aluminate and/or silicate precursor materials, one or more saccharides and water.

4. The two-component reactive system of claim 1 wherein the one or more inorganic aluminate and/or silicate precursor materials include an aluminosilicate and an alkali metal silicate.

5. The two-component reactive system of claim 4 wherein the alkali metal silicate is present in the first alkaline aqueous premix.

6. The two-component reactive system of claim 4 wherein the aluminosilicate is metakaolin.

7. The two-component reactive system of claim 6 wherein the metakaolin is present in the first alkaline aqueous premix.

8. The two-component reactive system of claim 6 wherein the metakaolin is present in the second aqueous premix.

9. The two-component reactive system of claim 6 wherein a portion of the metakaolin is present in the first alkaline aqueous premix and another portion of the metakaolin is present in the second aqueous premix.

10. The two-component reactive system of claim 1 wherein the one or more saccharides is a reducing monosaccharide.

11. The two-component reactive system of claim 10 wherein the reducing monosaccharide is xylose.

12. The two-component reactive system of claim 1 wherein the one or more saccharides is present in the first alkaline aqueous premix.

13. The two-component reactive system of claim 1 wherein the one or more saccharides is present in the second aqueous premix.

14. The two-component reactive system of claim 1 wherein a portion of the one or more saccharides is present in the first alkaline aqueous premix and another portion of the one or more saccharides is present in the second aqueous premix.

15. The two-component reactive system of claim 1 comprising at least 5 moles of the one or more water-soluble peroxy compounds per mole of the one or more saccharides.

16. The two-component reactive system of any of claim 1 wherein the one or more water-soluble peroxy compounds is hydrogen peroxide.

17. The two-component reactive system of claim 1 wherein at least one of the first alkaline aqueous premix and the second aqueous premix further comprises at least one material selected from the group consisting of a) organic and/or silicone surfactants and b) water-soluble and/or water-dispersible organic polymers.

18. The two-component reactive system of claim 1 wherein at least one of the first alkaline aqueous premix and the second aqueous premix further comprises a catalytic amount of a transition metal catalyst for the reaction of the one or more water-soluble peroxy compounds and the one or more saccharides.
